(19) United States
(12) Patent Application Publication
(10) Pub. No.: US 2007/0257901 A1
(43) Pub. Date: Nov. 8, 2007

(54) SEMICONDUCTOR CHIP FOR DRIVING LIGHT EMITTING ELEMENT, LIGHT EMITTING DEVICE, AND LIGHTING DEVICE

(75) Inventors: Shusaku Gotou, Kyoto (JP); Tsukasa Kawahara, Kyoto (JP); Tadaaki Ikeda, Kagoshima (JP); Tooru Aoyagi, Kagoshima (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/599,966

(22) PCT Filed: Apr. 18, 2005
(86) PCT No.: PCT/JP05/07412

§ 371 Date: Oct. 16, 2006

(30) Foreign Application Priority Data
Apr. 19, 2004 (JP) 2004/123453

(51) Int. Cl. G09G 5/00

(52) U.S. Cl. 345/212

(57) ABSTRACT

There is provided a light emitting device having a small area for mounting. The light emitting device of the invention includes a light emitting element having an electric signal terminal, that is driven to emit light by an electric signal given to the electric signal terminal from outside, and a semiconductor chip for driving the light emitting element, having a light emitting element drive circuit that is made of a semiconductor, outputs and applies the electric signal to the electric signal terminal. The light emitting elements are mounted on the surface of the semiconductor chip for driving the light emitting element, and a conductive path is provided for mutually connecting a plurality of light emitting elements on the surface of the semiconductor chip for driving the light emitting element.

### TECHNICAL FIELD

The invention relates to a semiconductor chip for driving light emitting elements, a light emitting device, and a lighting device.

### BACKGROUND ART

In a portable telephone, a digital camera, and other electronic appliances, recently, there is an increasing opportunity for using a light emitting device for driving a light emitting element such as a visible light emitting diode (a visible LED), and a lighting device having a plurality of the light emitting devices. As electronic appliances are advanced in integration, the market is demanding light emitting devices having a smaller mounting area. Since visible light emitting diodes and other light emitting elements are likely to be broken by static electricity or voltage, protective elements are needed. Furthermore, a driver IC for driving light emitting elements is necessary, so that the mounting area of light emitting device tends to be wider.

JP-A-2003-8075 (patent document 1) discloses a technology of curtailing a mounting area of light emitting device by mounting light emitting elements on a protective element to form one luminous module. Referring to FIG. 12 to FIG. 14, the conventional light emitting device disclosed in patent document 1 is explained. FIG. 12 is a plan view of the conventional light emitting device, FIG. 13 is a sectional view along broken line A-A′ in FIG. 12. FIG. 14 is a circuit diagram of the conventional light emitting device shown in FIG. 12 and FIG. 13. In FIG. 12 to FIG. 14, same elements are identified with same reference numerals.

Firstly, FIG. 12 and FIG. 13 are explained. The conventional light emitting device has a substrate wiring 1203 (including VCC wiring and GND wiring) on a substrate 1202. A luminous module 1201, a power supply circuit 104, and a driver IC 1204 are mounted on the substrate wiring 1203. Individual elements of internal circuit of the light emitting module 1201, the power supply circuit 104, and the driver IC 1204 are electrically connected by the substrate wiring 1203.

The power supply circuit 104 has an input capacitor 143 connected between the VCC wiring and the GND wiring, a coil 141 connected to the input capacitor 143 through the VCC wiring, a Schottky diode 142 connected to the coil 141 through the substrate wiring 1203, and an output capacitor 144 having one end connected to the Schottky diode 142 and a voltage feedback terminal 125 by way of the substrate wiring 1203 and other end connected to the GND wiring.

Each of elements of the luminous module 1201 is explained. In the luminous module 1201, a lead frame 114 is mounted above the substrate 1202. Zener diodes 1213 are fixed on the lead frame 114. The upsides of the zener diodes 1213 are covered with insulating films 131 except for pad holes 113.

Bumps 115 are put on pad holes 113 except for the portion near the both ends on the zener diodes 1213, and the light emitting elements 111 are mounted on bumps 115. The light emitting elements 111 are visible light emitting diodes (LED). The zener diodes 1213 protect the light emitting elements 111 from electrostatic breakdown and high voltage breakdown.

In FIG. 12 and FIG. 13, each of light emitting elements 111 is mounted on each of two zener diodes 1213. The mounting area of the conventional light emitting device is smaller than a structure of mounting zener diodes 1213 and light emitting elements 111 individually because the light emitting elements 111 are mounted on the zener diodes 1213 to form an incorporated module.

One ends of two bonding wires 116 are connected to pad holes 113 near both ends of the zener diodes 1213. Other end of one bonding wire 116 is connected to an anode side terminal 1253, and other end of another bonding wire 116 is connected to a cathode side terminal 1254.

A convex lens 119 is disposed above the light emitting elements 111. The convex lens 119 concentrates the light of light emitting elements 111, intensifies the light directivity, and heightens the luminance in a vertical direction to the substrate 1202.

A light permeable resin mold 117 covers the entire structure including the light emitting elements 111, the zener diodes 1213, the lead frame 114, and the convex lens 119, and is combined with the substrate 1202. The upper half of the light permeable resin mold 117 is parabolic form and forms a reflection surface for reflecting and concentrating the total light effectively.

Each of elements of the driver IC 1204 is explained. In the driver IC 1204, the lead frame 114 is mounted above the substrate 1202. A driver IC chip 112 is fixed on the lead frame 114. The upside of the driver IC chip 112 is covered with the insulating film 131 except for pad holes 113.

One ends of six bonding wires 116 are connected six pad holes, and other end of each bonding wire 116 is connected to each of external connection terminals (including a control terminal 123, a voltage feedback terminal 125, a switching terminal 124, a current feedback terminal 126, a VCC terminal 121, and a GND terminal 122). Thus, through plural bonding wires 116, the driver IC chip 112 is electrically connected to external connection terminals.

The VCC terminal 121 is connected to the VCC wiring. The GND terminal 122 is connected to the GND wiring. The control terminal 123 is a terminal for receiving a signal for switching on/off the driver IC 1204. When an input voltage input to the control terminal 123 is high, the driver IC chip 112 is operates to cause the light emitting elements 111 to emit light continuously. When the input voltage is low, the driver IC chips 112 stops operation to cause the light emitting elements 111 to stop emitting light. By applying a pulse voltage to the control signal 123, blinking on and off of light emitting elements 111 can be repeated.

The switching terminal 124 is connected to the anode terminal of the Schottky diode 142 and the coil 141 through the substrate wiring 1203. The voltage feedback terminal 125 is connected to the cathode terminal of Schottky diode 142, the anode side terminal 1253 of luminous module 1201, and an output capacitor 144 through the substrate wiring 1203. The current feedback terminal 126 is connected to the cathode side terminal 1254 of luminous module 1201 through the substrate wiring 1203.

A circuit configuration of conventional light emitting device in FIG. 14 is explained, As shown in FIG. 14, the conventional light emitting device has a power supply circuit 104 that increases the output voltage from an external power supply 140, the driver IC 1204 connected to the power supply circuit 104 through external connection terminal (including the VCC terminal 121, the switching terminal 124, and the voltage feedback terminal 125), and the luminous module 1201 connected to the power supply circuit 104 through the anode side terminal 1253 and connected to the driver IC 1204 through the cathode side terminal 1254.

In FIG. 14, the circuit shown in the frame of driver IC 1204 is an internal circuit mounted on the driver IC chip 112. The driver IC chip 112 has a first protective circuit 501 connected between the voltage feedback terminal 125 and the GND terminal 122, a second protective circuit 1401 connected between the VCC terminal 121 and the GND terminal 122 with a current feedback terminal 126 connected to the intermediate connection point of the second protective circuit 1401, a current detection resistor 504 connected between the current feedback terminal 126 and the ground potential, a voltage detection circuit 503 connected to the control terminal 123, the voltage feedback terminal 125, and the current feedback terminal 126, and a driving circuit 502 connected to the control terminal 123, the voltage detection circuit 503, and the switching terminal 124.

The first protective circuit 501 protects the voltage detection circuit 503 from electrostatic breakdown due to a surge applied to the voltage feedback terminal 125. The first protective circuit 501 is composed of a zener diode, a MOS transistor or a bipolar transistor. The first protective circuit 501 in FIG. 14 is a zener diode.

The second protective circuit 1401 protects the internal circuit of the driver IC chip 112 from electrostatic breakdown due to a surge applied to the current feedback terminal 126. In FIG. 14, the second protective circuit 1401 is composed of two diodes connected in series.

The driving circuit 502 drives the coil 141 and Schottky diode 142 through the switching terminal 124, and increases an input voltage from external power supply 140. As a result, a higher voltage than the input voltage is applied to the output capacitor 144 as an output voltage. The voltage of the output capacitor 144 is applied to the anode side of one of the light emitting elements 111 through the anode side terminal 1253 of the luminous module 1201.

In the luminous module 1201, a pair of the zener diodes 1213 and a pair of the light emitting elements 111 are connected in parallel. The zener diodes 1213 protects the light emitting elements 111 from a surge applied to the anode side terminal 1253 or the cathode side terminal 1254 when mounting the luminous module 1201.

The cathode side terminal 1254 of the luminous module 1201 is connected to the current feedback terminal 126 connected to the current detection resistor 504 in the driver IC chip 112. The voltage detection circuit 503 keeps the current flowing into the light emitting elements 111 constant by keeping the terminal voltage of current detection resistor 504 constant. The voltage detection circuit 503 detects and controls the output voltage so that the voltage of the voltage feedback terminal 125 may not exceed a specified value.

Since the driving circuit 502 and the voltage detection circuit 503 in the prior art are same as that in the invention, the internal circuits are omitted or simplified in FIG. 14. The detail of internal circuit of the driving circuit 502 and the voltage detection circuit 503 is explained in an embodiment 1 of the invention.

Patent document 1: JP-A-2003-8075

### DISCLOSURE OF INVENTION

### Problems to be Solved by the Invention

The conventional light emitting device explained above tends to be increased in mounting area because the luminous module 1201 including the light emitting element 111 and the driver IC 1204 including the driver IC chip 112 are mounted on different lead frames. In particular, when a plurality of light emitting elements 111 are used, the space occupied by zener diodes 1213 is increased, and it is a problem. In the conventional light emitting device, since the protective elements 1213 for protecting the light emitting elements 111 from electrostatic breakdown or high voltage breakdown, and the driver IC 112 for driving the light emitting elements 111 are indispensable, and they cannot be eliminated in order to reduce the mounting area.

The invention is devised to solve the above problems, and it is an object to provide a light emitting device having a small mounting area.

It is also an object of the invention to present an inexpensive semiconductor chip for driving light emitting elements to be used in combination with an arbitrary number of light emitting elements.

It is another object of the invention to present an inexpensive lighting device.

It is a further object of the invention to present an lighting device having high luminance and small size.

### Means for Solving the Problems

To solve the problems, the invention has the following configuration.

A light emitting device according to one aspect of the invention has: a light emitting element having an electric signal terminal, that is driven to emit light by an electric signal given to the electric signal terminal from outside; and a semiconductor chip for driving the light emitting element, having a light emitting element drive circuit that is made of a semiconductor, outputs and applies the electric signal to the electric signal terminal, in which the light emitting element is mounted on the surface of the semiconductor chip for driving the light emitting element.

In the invention, by mounting the light emitting element on the semiconductor chip for driving the light emitting element (driver IC chip), a light emitting device having a small mounting area is realized.

In the light emitting device according to another aspect of the invention, the semiconductor chip for driving the light emitting element has a protective circuit that protects the light emitting element or the light emitting element drive circuit from static electricity or high voltage applied from the outside (“static electricity” or “high voltage” is called “surge voltage” hereinafter); and a protective terminal that connects the protective circuit electrically to the outside; and the protective terminal is connected to the electric signal terminal of the light emitting element.

In the process of forming a protective circuit for protecting an internal circuit of the driver IC chip, by disposing the protective circuit for the light emitting element on the driver IC chip, or by disposing the protective circuit for protecting the internal circuit of driver IC chip and protecting the light emitting elements, a high reliable light emitting device can be realized at low cost. According to the invention, since the conventional first protective circuit only for protecting the light emitting element from surge voltage applied from the outside is not provided the outside of the driver IC chip, as compared with the prior art, an inexpensive light emitting device of smaller mounting area can be realized.

In the light emitting device according to another aspect of the invention, the protective circuit has one or a plurality of elements made by same manufacturing method as elements forming the light emitting element drive circuit of the semiconductor chip for driving the light emitting element.

For example, the protective circuit is formed by using at least one of a PN junction diode, a bipolar transistor, and a MOS transistor. This invention realizes a light emitting device of low cost, high reliability, and small mounting area.

In the light emitting device according to other aspect of the invention, a plurality of light emitting elements formed from different chips are mounted on the surface of the semiconductor chip for driving the light emitting element, and the semiconductor chip for driving the light emitting element has a conductive path for mutually connecting light emitting elements.

By forming the conductive path only for mutual connection of plural light emitting elements on the driver IC chip, a light emitting device having small mounting area can be realized at low cost.

The conductive path may be a conductor having a very low resistance value, or may be a path for producing a specified resistance value or specified voltage drop. Generally, the conductive path is preferably made of a conductor having an extremely low resistance value. The conductive path may be made of a diffusion layer in the semiconductor substrate of the driver IC chip, or may be formed on the semiconductor substrate by evaporation, adhesion, application or other arbitrary method. The material of conductive path is not particularly specified. For example, it is a diffusion layer, metal wiring layer, or resin conductive layer formed on the driver IC chip.

In the light emitting device according to other aspect of the invention, the conductive path is made of a diffusion layer or a metal wiring layer formed by same processing method as a diffusion layer or a metal wiring layer forming the light emitting element drive circuit in the semiconductor chip for driving the light emitting element.

This invention realizes a light emitting device having a small mounting area at low cost.

In the light emitting device according to other aspect of the invention, the conductive path has a resistance having a specified value.

According to the invention, the current flowing into each light emitting element can be made uniform, for example, by detecting the temperature near the light emitting elements on the basis of changes of a resistance value of the conductive path, detecting the current flowing into the light emitting elements on the basis of voltage at both ends of the conductive path, or connecting the conductive path having a resistance value in series to each light emitting element in the circuit connecting a plurality of light emitting elements in parallel.

In the light emitting device according to other aspect of the invention, a plurality of visible light emitting elements emitting light at different wavelengths are provided.

According to this invention, since plural light emitting elements having different light emitting colors are disposed at very close positions, if plural light emitting elements are emitted at the same time, colors of plural light emitting elements are mixed uniformly, and uneven colors are hardly formed when seen from any direction.

In the light emitting device according to other aspect of the invention, the light emitting elements include plural visible light emitting elements emitting tree primary colors of red, green and blue.

The light emitting device of this invention can display in color. Since the light emitting device has the driver IC chip, peripheral circuits can be curtailed, and plural light emitting devices can be connected easily. The mounting area of the light emitting device is small, and the rate of light emitting area occupied in the total area of each light emitting device is large. When a plurality of light emitting devices are disposed closely, in a display device (lighting device) having light emitting devices, higher luminance than in the prior art can be realized. For example, it is suitable for an outdoor image display device.

In the light emitting device according to other aspect of the invention, the plurality of light emitting elements are disposed closely to a focus of a transmission type condensing lens combined in the light emitting device.

By disposing the light emitting elements near the focus of the condensing optical system, the light emitted by the light emitting elements can be concentrated in a specific direction. Due to restriction in precision of mounting light emitting elements on circuit board, in the conventional light emitting device disposing a plurality of light emitting elements on the circuit board, each light emitting element is disposed at a certain spacing. Accordingly, the plural light emitting elements are disposed at position slightly remote from the focus of condensing optical system. For example, plural light emitting elements are disposed at positions slightly remote from the parabolic focus beneath a slightly large parabolic reflection plane, and individual resin convex lenses are disposed immediately above each light emitting element in the bottom of parabolic form. As a result, a part of light emitted from the light emitting elements is not directed in specific direction, and the light concentration rate is not raised higher than a specific level. The invention realizes a light emitting device having a higher light concentration rate and a stronger directivity than in the prior art.

In the light emitting device according to other aspect of the invention, the plurality of light emitting elements are disposed near a focus of a reflection plane combined in the light emitting device.

The reflection plane is typically a transparent resin reflection plane that performs total reflection of lights in the inside. This invention realizes a light emitting device having a high light concentration rate and a strong directivity.

A lighting device according to one aspect of the invention has a plurality of above-mentioned light emitting devices. Each of the light emitting devices includes the semiconductor chip for driving a light emitting element. The semiconductor chip has a constant current circuit for applying a specified current to the light emitting element or a constant voltage circuit for applying a specified voltage to the light emitting element.

This invention realizes an inexpensive lighting device that simplifies mutual wirings of light emitting devices. By disposing the light emitting devices closely, a lighting device having higher luminance and/or smaller size than in the prior art is realized. The lighting device includes, for example, an ordinary lighting device, a large display panel, and a video display device.

A semiconductor chip for driving light emitting elements according to one aspect of the invention is capable of mounting a plurality of light emitting elements. Each of the light emitting elements has an electric signal terminal and is driven to emit light by an electric signal given to the electric signal terminal. The semiconductor chip for driving light emitting elements has: a light emitting element drive circuit that is made of a semiconductor, outputs and applies the electric signal to the electric signal terminal; and a conductive path that connects the electric signal terminals of the plurality of light emitting elements each other.

According to this invention, by forming the conductive path only for mutual connection of plural light emitting elements on the semiconductor chip for driving light emitting elements (driver IC chip), a semiconductor chip for driving light emitting elements of a low cost and a small mounting area is realized.

In the semiconductor chip for driving light emitting elements according to another aspect of the invention, P (P is a positive integer of 1 or more) light emitting elements formed by different chips and circuit elements of the light emitting element drive circuit are mutually connected through bumps provided on the conducive path.

This invention realizes a semiconductor chip for driving light emitting elements of a low cost that does not require wire bonding and have a small mounting area.

In the semiconductor chip for driving light emitting elements according to other aspect of the invention, the conductive path has a conductive path shape such that Q (Q is a positive integer different from P) light emitting elements having nearly same shape as P light emitting elements are operable to be mounted, instead of P light emitting elements.

According to this invention, by changing the location of light emitting elements with one kind of conductive path pattern (for example, aluminum wiring pattern), plural light emitting devices having different numbers of light emitting elements can be manufactured. According to this invention, only one mask is needed for forming a conductive path pattern. Light emitting devices according to demands can be manufactured by assembling one kink of driver IC chip and arbitrary light emitting elements, so that the stock of driver IC chips as material of LED can be saved. This invention curtails a management cost in a factory.

The semiconductor chip for driving light emitting elements according to other aspect of the invention has an external connection terminal that varies the value of current or voltage for driving the light emitting elements.

For example, the setting of driver IC chip may be changed when the driver IC chip drives one light emitting element and when driving four light emitting elements. The semiconductor chip for driving light emitting elements of the invention can vary the current flowing into the light emitting elements from the external connection terminal or the voltage applied to the light emitting elements, and therefore multiple kinds of light emitting devices can be manufactured by using one kind of driver IC chip.

While the novel features of the invention are set forth particularly in the appended claims, the invention, both as to organization and content, will be better understood and appreciated, along with other objects and features thereof, from the following detailed description taken in conjunction with the drawings.

It will be recognized that some or all of the drawings are schematic representations for purposes of illustration and do not necessarily depict the actual relative sizes or locations of the elements shown.

### EFFECTS OF THE INVENTION

The invention has an outstanding effect of realizing a light emitting device having a small mounting area.

The invention realizes an inexpensive light emitting device having high reliability by eliminating a protective element such as a zener diode required in the prior art.

The invention realizes a light emitting device that makes high capacity to resist pressure of electrostatic breakdown of external connection terminals of a luminous module.

In the light emitting device of the invention, since light emitting elements are mounted on the driver IC chip, as compared with the prior art, parasitic resistance and stray capacitance of substrate wiring are reduced. As a result, it is easy to design the phase compensation for stabilizing a current value. The invention has an effect that luminance of light is stable and flickering of light is eliminated.

The invention realizes an inexpensive semiconductor chip for driving light emitting elements that can be combined with an arbitrary number of light emitting elements.

The invention realizes an inexpensive lighting device.

The invention realizes a lighting device having high luminance and small size.

### BRIEF DESCRIPTION OF DRAWINGS

FIG. 1 is a plan view showing structure of a light emitting device in an embodiment 1 of the invention.

FIG. 2 is a sectional view along broken line A-A′ in FIG. 1.

FIG. 3 is a partial magnified sectional view of a driver IC chip in the embodiment 1 of the invention.

FIG. 4 is a plan view showing a shape of aluminum wirings for connecting light emitting elements and the driver IC chip of the light emitting device in the embodiment 1 of the invention.

FIG. 5 is a circuit diagram of the light emitting device in the embodiment 1 of the invention.

FIG. 6 is a circuit diagram of a light emitting device in an embodiment 2 of the invention.

FIG. 7 is a circuit diagram of a protective circuit in an embodiment 3 of the invention.

FIG. 8 is a circuit diagram of a protective circuit in an embodiment 4 of the invention.

FIG. 9 is a circuit diagram of a protective circuit in an embodiment 5 of the invention.

FIG. 10 is a partial magnified sectional view of a driver IC chip in an embodiment 6 of the invention.

FIG. 11 is a partial magnified sectional view of a driver IC chip in an embodiment 7 of the invention.

FIG. 12 is a plan view of structure of a light emitting device in prior art.

FIG. 13 is a sectional view along broken line A-A′ in FIG. 12.

FIG. 14 is a circuit diagram of the light emitting device in prior art.

FIG. 15 is a plan view showing shapes of aluminum wirings for connecting the light emitting elements and the driver IC chip of the light emitting device in embodiment 8 of the invention.

### BEST MODE FOR CARRYING OUT THE INVENTION

Embodiments specifically showing the best mode for carrying out the invention are described below together with the drawings.

### Embodiment 1

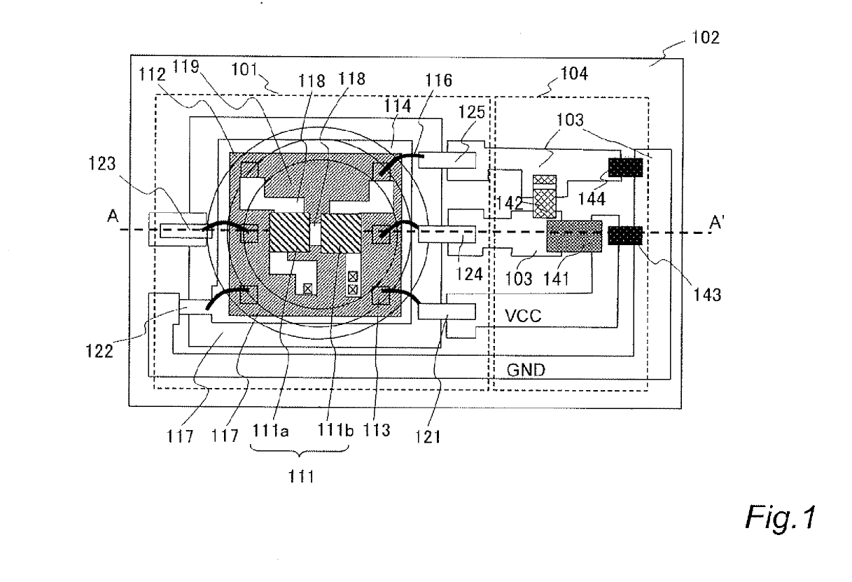

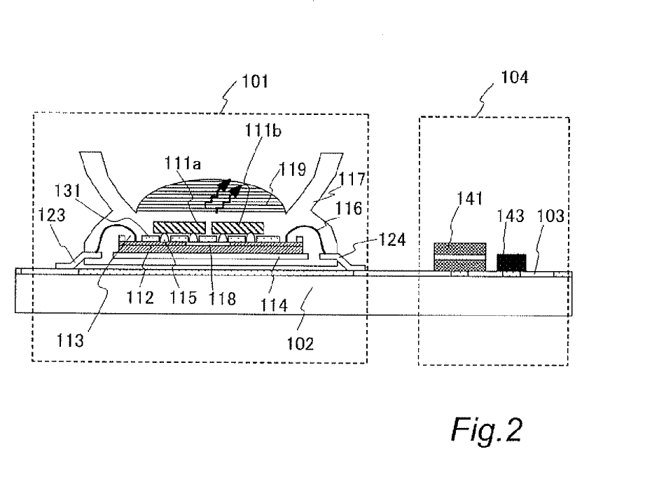

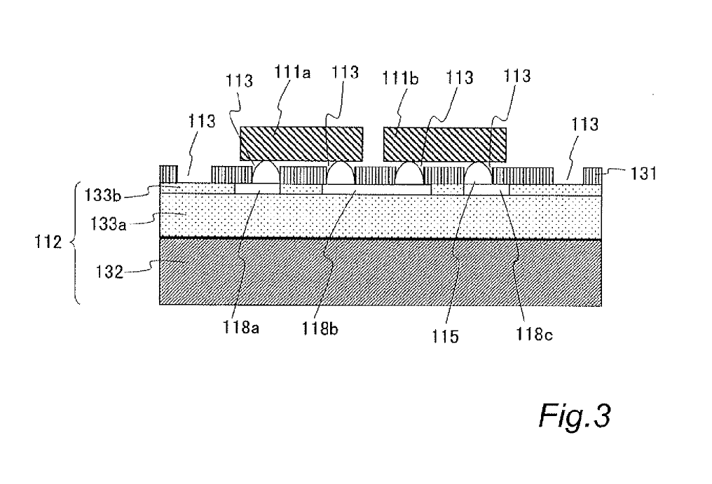

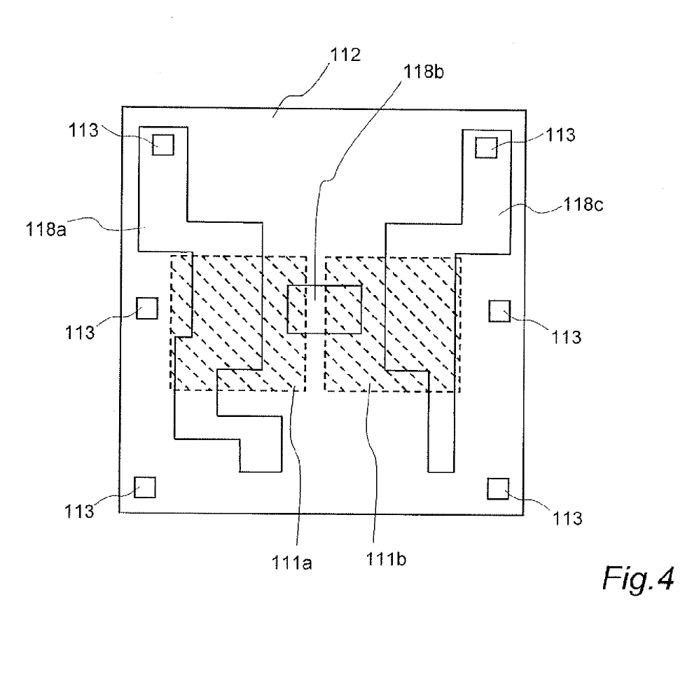

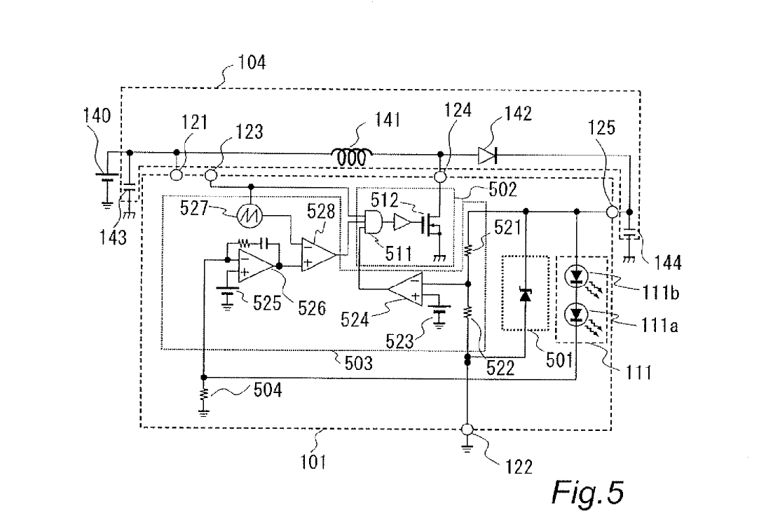

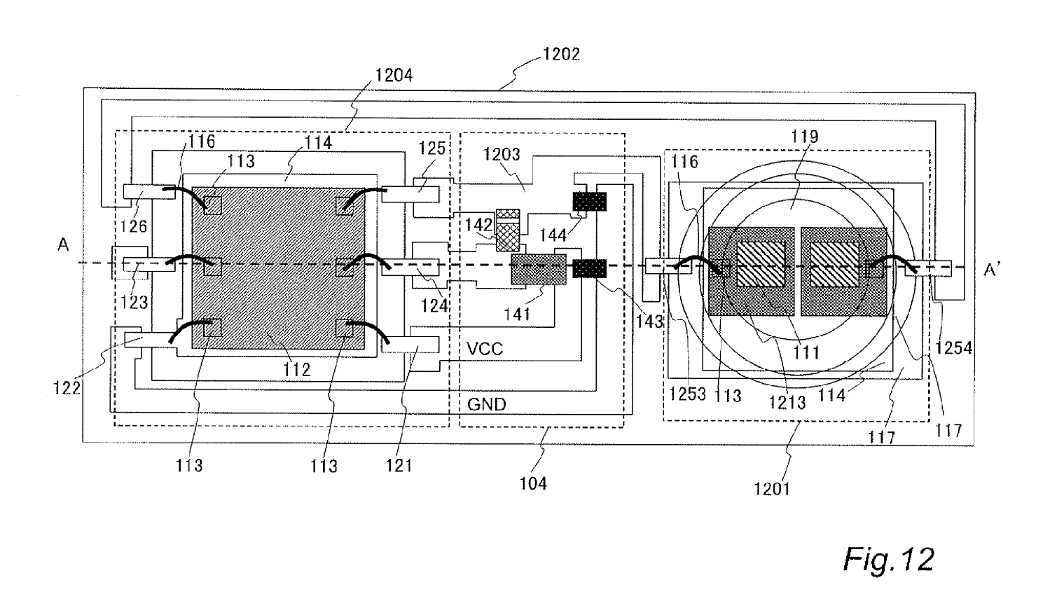

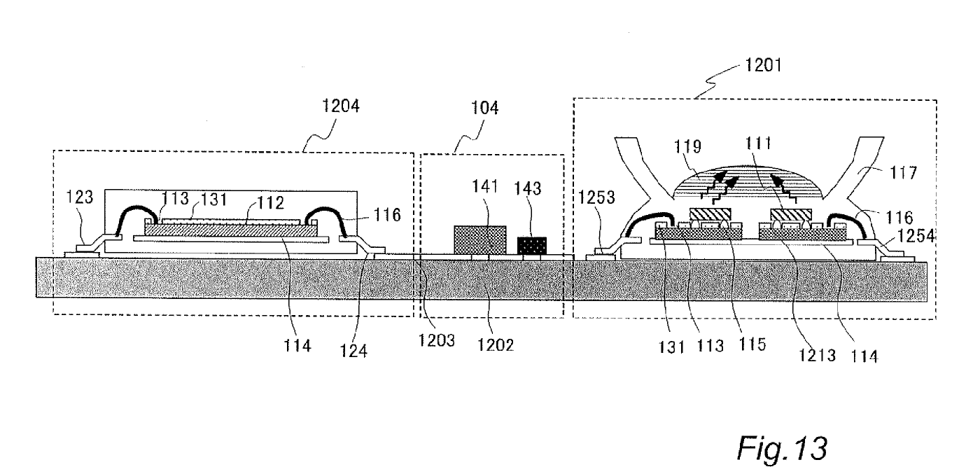

Referring to FIG. 1 to FIG. 5, a light emitting device in an embodiment 1 of the invention is described below. FIG. 1 is a plan view of structure of the light emitting device in the embodiment 1 of the invention. FIG. 2 is a sectional view along broken line A-A′ in FIG. 1. FIG. 3 is a partial magnified sectional view of a driver IC chip 112. FIG. 4 is a plan view showing shapes of aluminum wirings for connecting light emitting elements 111a and 111b being LED and the driver IC chip 112. FIG. 5 is a circuit diagram of the light emitting device in the embodiment 1 of the invention. In FIG. 1 to FIG. 5, same elements are identified with same reference numerals. In FIG. 1 to FIG. 5, same elements as FIG. 12 to FIG. 14 in the prior art are identified with same reference numerals.

In FIG. 1 and FIG. 2, the light emitting device in embodiment 1 of the invention is described. The light emitting device in embodiment 1 of the invention has substrate wirings 103 (including a VCC wiring and a GND wiring) on a substrate 102, and mounts a power supply circuit 104 and a luminous module 101 on the substrate wirings 103. Elements of a internal circuit of the luminous module 101 and elements of a internal circuit of the power supply circuit 104 are electrically connected through the substrate wirings 103. The VCC wiring is connected to an external power supply, and the GND wiring is connected to a ground potential.

The power supply circuit 104 has an input capacitor 143 connected between the VCC wiring and the GND wiring, a coil 141 connected to the input capacitor 143 through the VCC wiring, a Schottky diode 142 connected to the coil 141 through the substrate wirings 103, and an output capacitor 144 having one end connected to the Schottky diode 142 through the substrate wirings 103, and another end connected to the GND wiring.

The luminous module 101 includes external connection terminals (including a VCC terminal 121, a GND terminal 122, a control terminal 123, a switching terminal 124, and a voltage feedback terminal 125) connected to the power supply circuit 104 by the substrate wirings 103.

The VCC terminal 121 is connected to the VCC wiring. The GND terminal 122 is connected to the GND wiring. The control terminal 123 is connected to an output of a control circuit such as a microcomputer, and receives a signal for changing over light emission and stopping of light emitting elements 111a and 111b.

The switching terminal 124 is connected to an anode terminal of the Schottky diode 142 and the coil 141 through the substrate wiring 103. The voltage feedback terminal 125 is connected to a cathode terminal of the Schottky diode 142 and the output capacitor 144 through the substrate wiring 103.

Each of elements in the luminous module 101 are further described. In the luminous module 101 according to the embodiment 1 of the invention, a lead frame 114 is mounted above the substrate 102, and the driver IC chip (the semiconductor chip for driving light emitting elements) 112 is fixed on the lead frame 114. The upside of the driver IC chip 112 is covered with an insulating film 131 except pad holes 113. The pad holes 113 are portions not covered with the insulating film 131 on the driver IC chip 112. Except for the portions near the both ends, bumps 115 are provided in pad holes 113, and the light emitting elements 111a and 111b are mounted on bumps 115.

What the light emitting device of the invention differs from the conventional light emitting device lies in the features that the driver IC chip 112 is built in the light emitting module 101, and that the light emitting elements 111a and 111b are mounted on the driver IC chip 112. Accordingly, the size of the substrate 102 of the invention is smaller than that of the substrate 1202 in the prior art. In the light emitting device of the invention, since the light emitting elements 111a and 111b are mounted on the driver IC chip 112, the mounting area of light emitting device can be smaller than that in the prior art.

The light emitting elements 111a and 111b (both are collectively indicated as “light emitting elements 111”) are made of discrete chips. In the embodiment 1 of the invention, a plurality of light emitting elements are mounted on the driver IC chip 112. In FIG. 1 to FIG. 5, two light emitting elements 111a and 111b are mounted.

The light emitting elements 111a and 111b are visible light emitting diodes (LED). Color of light emitting elements may be used as desired. In embodiment 1, the light emitting elements 111a and 111b are blue light emitting diodes, and radiate white light to the outside through a transmission type condenser lens 119 coated with white fluorescent substance on the surface. In the invention, plural light emitting elements may emit light at different wavelengths. The convex lens 119 disposed above the light emitting elements 111 concentrates light of light emitting elements 111, intensifies the light directivity, and heightens the luminance in a vertical direction to the substrate 102.

The light permeable resin mold 117 covers, fixes and protects the entire structure including the light emitting elements 111, the driver IC chip 112, the lead frame 114, and the convex lens 119. The light permeable resin mold 117 condenses light of light emitting elements 111, and adjusts the luminance and directivity of light. The upper half of the light permeable resin mold 117 has a parabolic form, and forms a reflection plane for reflecting and condensing total light effectively to heighten the luminance in a vertical direction to the substrate 102.

In the embodiment 1, the light permeable resin mold 117 and the convex lens 119 are made of same material to become one. The plural light emitting elements 111a and 111b are disposed near a focal point of one transmission type condensing lens 119 covered with white fluorescent substance on the surface and one reflection plane 117 which are formed in the light emitting device to unify.

FIG. 3 is a partial magnified view of the upside of driver IC chip 112. The upside of a P type silicon substrate 132 which is a substrate of the driver IC chip 112 is covered with an insulating film 133a. The upside of the insulating film 133a is covered with an insulating film 133b except for positions of aluminum wirings 118a, 118b, and 118c being conductive path.

In embodiment 1, the insulating film 133a and the insulating film 133b are oxide films (SiO₂). A material of insulating films 133a and 133b is not limited to the oxide film (SiO₂), but may be a nitride film (SiN), high polymer (polyimide, etc.), and resin (epoxy, etc.).

The upside of the insulating film 133b and the upside of the aluminum wirings 118a, 118b and 118c are covered with the insulating film 131 except for pad holes 113. The pad holes 113 are provided for connecting bonding wires 116, and for disposing bumps 115. Bumps 115 are provided at specified positions of pad holes 113 on aluminum wirings 118a, 118b and 118c.

The light emitting elements 111a and 111b are mounted on bumps 115, The light emitting elements 111a and 111b are connected to the aluminum wirings 118a, 118b and 118c on the driver IC chip 112 through bumps 115.

In the pad holes 113 near the both ends shown in FIG. 3, bonding wires 116 are connected as shown in FIG. 1 and FIG. 2. The driver IC chip 112 connects the internal circuit and the external connection terminals (which includes the VCC terminal 121, the GND terminal 122, the control terminal 123, the switching terminal 124, and the voltage feedback terminal 125) electrically through bonding wires 116.

As shown in the shape of aluminum wirings in FIG. 4 and the circuit diagram in FIG. 5, the anode (electric signal terminal) of light emitting element 111b is connected to the internal circuit elements of driver IC chip 112 and the voltage feedback terminal (protective terminal) 125 by way of the bumps 115 and the aluminum wiring 118c. The cathode of light emitting element 111b is connected to the anode of light emitting element 111a by way of bumps 115 and the aluminum wiring 188b. The cathode of light emitting element 111a is connected to the internal circuit elements (resistance element 504 for current feedback and others) of the driver IC chip 112 by way of the bumps 115 and the aluminum wiring 118a. The anodes and cathodes of light emitting elements 111a and 111b are electric signal terminals.

The aluminum wiring 118b only has the role of connecting the cathode of light emitting element 111b and the anode of light emitting element 111a. The aluminum wiring 118b is not connected to the circuit elements formed on the driver IC chip 112.

Instead of aluminum wirings 118a, 118b, and 118c in the embodiment 1 of the invention, by using conductive path made of a metal wiring layer, or a diffusion layer or the like, the driver IC chip 112 and plural light emitting elements 111a and 111b may be mutually connected. The metal wiring layer is made of, for example, aluminum, gold or copper.

The circuit diagram of the light emitting device in the embodiment 1 in FIG. 5 is explained. As shown in FIG. 5, the light emitting device in embodiment 1 of the invention has a power supply circuit 104 that increases an output voltage of an external power supply 140, and the luminous module 101 connected to the power supply circuit 104 by way of the external connection terminals (the VCC terminal 121, the switching terminal 124, and the voltage feedback terminal 125).

In the power supply circuit 104, one end of the input capacitor 143 is connected to the external power supply 140. Other end of the input capacitor 143 is connected to the ground potential. The coil 141 is connected to the input power supply 140 and the anode terminal of Schottky diode 142. The cathode terminal of Schottky diode 142 is connected to one end of the output capacitor 144. Other end of the output capacitor is connected to the ground potential.

A driving circuit 502, a voltage detection circuit 503, and a current detection resistor 504 shown within the frame of the luminous module 101 in FIG. 5 are elements of the light emitting element drive circuit mounted on the driver IC chip 112. The driver IC chip 112 drives by receiving power from the VCC terminal 121 connected between the input capacitor 143 and the coil 141.

The voltage feedback terminal 125 is connected between the cathode terminal of Schottky diode 142 and the output capacitor 144 to receive an output voltage. The GND terminal 122 is connected to the ground potential.

Between the voltage feedback terminal 125 and the GND terminal 122, the first protective circuit 501, and a first voltage dividing resistor 521 and a second voltage dividing resistor 522 in a voltage detection circuit 503 are connected in parallel.

In the embodiment 1, the first protective circuit 501 is a zener diode. The first protective circuit 501 protects the voltage detection circuit 503 from electrostatic breakdown due to the surge voltage applied to the voltage feedback terminal 125.

The anode of light emitting element 111b is further connected to the voltage feedback terminal 125. The cathode of light emitting element 111b is connected to the anode of light emitting element 111a. The cathode of the light emitting element 111a is connected to the ground potential by way of the current detection resistor 504.

The anode side of light emitting element 111b is exposed electrically to the outside through the voltage feedback terminal 125. In the mounting process, the surge voltage applied to the anode of light emitting element 111b through the voltage feedback terminal 125 is absorbed by the first protective circuit 501 and hence the light emitting elements 111a and 111b are protected from electrostatic breakdown.

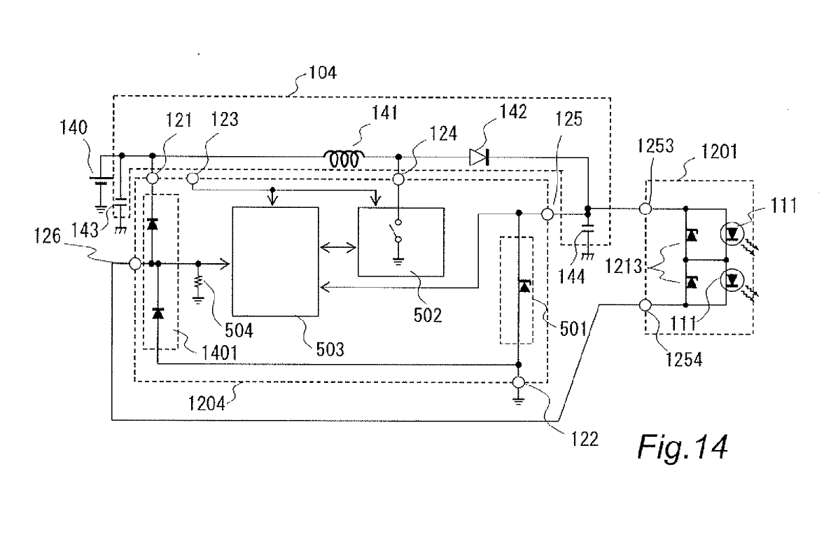

Although the first protective circuit 501 is primarily a circuit for protecting the inside of the driver IC chip 112, the first protective circuit 501 has functions as a protective circuit for the light emitting elements 111a and 111b because the first protective circuit 501 is connected to the light emitting element 111b in the luminous module 101. Therefore, in the light emitting device of the invention, the zener diode 1213 in FIG. 14 required in the conventional light emitting device can be omitted.

Since the cathode side of light emitting element 111a is connected to the current detection resistor 504 in the light emitting module 101, the cathode does not be applied with the surge voltage from the outside. Accordingly, in the light emitting device of the invention, the second protective circuit 1401 (FIG. 14) required in the conventional light emitting device is not necessary. As a result, as compared with the conventional light emitting device, the area of driver IC chip 112 can be made small.

A connection point of the light emitting element 111a and the current detection resistor 504 is connected to an inverting input terminal of an error amplifier 526. One end of a first reference voltage 525 is connected to a non-inverting terminal of the error amplifier 526. Other end of the first reference voltage 525 is connected to the ground potential. The output terminal of the error amplifier 526 is connected to a non-inverting input terminal of a PWM comparator 528, and is also connected to a inverting input terminal of the error amplifier 526 by way of a capacitor and a resistor.

One end of a sawtooth wave oscillator 527 is connected to the control terminal 123, and other end of the sawtooth wave oscillator 527 is connected to an inverting input terminal of the PWM comparator 528. An output terminal of the PWM comparator 528 is connected to an input terminal of an AND circuit 511 in the driving circuit 502.

By mutually connecting elements in the voltage detection circuit 503, negative feedback is operated so that the voltage between terminals of current detection resistor 504 may be equal to the first reference voltage 525 entered into the non-inverting input terminal of the error amplifier 526. By thus keeping the current flowing in the current detection resistor 504 constant, the current flowing in the light emitting element 111 is controlled constant, and brightness of light emission can be kept constant.

An output terminal of a comparator 524 is further connected to the input terminal of the AND circuit 511 in the driving circuit 502. The connection point of the first voltage dividing resistor 521 and the second voltage dividing resistor 522 is connected to an inverting input terminal of the comparator 524. One end of a second reference voltage 523 is connected to a non-inverting input terminal of the comparator 524. Other end of the second reference voltage 523 is connected to the ground potential.

The first voltage dividing resistor 521, the second voltage dividing resistor 522, the second reference voltage 523, and the comparator 524 are elements of a protective circuit for detecting and controlling an output voltage of the output capacitor 144 (voltage of the voltage feedback terminal 125) so that the output voltage may not exceed the specified value.

In the driving circuit 502, an output terminal of the AND circuit 511 is connected to a gate of a N channel MOS transistor 512 through an amplifier. A source of the N channel MOS transistor 512 is connected to the ground potential, and a drain is connected to the switching terminal 124.

The driving circuit 502 controls the on/off switching operation of N channel MOS transistor 512 by the output of AND circuit 511. By this switching operation, the input voltage produced from the external power supply 140 is increased, and a voltage higher than the input voltage is applied to the output capacitor 144.

The control terminal 123 is connected to the input terminal of the AND circuit 511. When the input voltage entering the control terminal 123 is high, the driver IC chip 112 is put in operation, and the driving circuit 502 drives the light emitting elements 111 to emit light continuously. When the input voltage is low, the driver IC chip 112 stops its operation, and the driving circuit 502 stops light emission of light emitting elements 111. Thus, on the basis of the input voltage applied to the control terminal 123, the driving circuit 502 controls the on/off switching of light emitting elements 111. By applying a pulse voltage to the control terminal 123, lighting and extinction of the light emitting elements 111 can be repeated.

In the light emitting device of the invention having such configuration, when constant current is supplied into light emitting elements 111a and 111b, the operation is as explained below. When the current flowing in the light emitting element 111a and the light emitting element 111b is increased, the terminal voltage of the current detection resistor 504 becomes higher. When the terminal voltage of the current detection resistor 504 becomes higher than the first reference voltage 525 and the difference of the terminal voltage of the current detection resistor 504 and the first reference voltage 525 increases, the output signal of the error amplifier 526 in the voltage detection circuit 503 becomes lower.

The output signal of the error amplifier 526 is entered in the non-inverting input terminal of PWM comparator 528, and the output signal of the oscillator 527 is entered in the inverting input terminal. A low period of the output signal of PWM comparator 528 becomes longer and a high period becomes shorter as the output signal of the error amplifier 526 becomes lower. While the output signal of the PWM comparator 528 is high, the N channel MOS transistor 512 is turned on. Since the ON time is shorter, the amount of current entered from the external power supply 140 and accumulated in the coil 141 becomes smaller.

Since the current accumulated in the coil 141 is smaller, the output signal of the PWM comparator 528 becomes low, and when the N channel MOS transistor 512 is turned off, the voltage value applied to the output capacitor 144 and the voltage feedback terminal 125 are smaller. The current flowing from the voltage feedback terminal 125 into the light emitting element 111a and light emitting element 111b becomes smaller. As a result, the terminal voltage of the current detection resistor 504 drops, and the difference between the terminal voltage of the current detection resistor 504 and the first reference voltage 525 decreases.

When the current flowing in the light emitting elements 111a and 111b is decreased, the operation is reverse of the case explained above. In this way, the switching operation of the N channel MOS transistor 512 in the driving circuit 502 is controlled by the voltage detection circuit 503 so that the terminal voltage of the current detection resistor 504 may be equal to the first reference voltage 525. As a result, a constant current flows in the light emitting elements 111.

In the light emitting device in embodiment 1 of the invention, the current feedback terminal 126 as the external connection terminal is not provided in the luminous module 101. In the conventional light emitting device, the current feedback terminal 126 is provided in the driver IC 1204, and is connected to the cathode side terminal 1254 of the luminous module 1201 in the prior art. In embodiment 1 of the invention, the light emitting elements 111 and the driver IC chip 112 are installed in the luminous module 101, and are connected to each other, and hence the current feedback terminal 126 used in the prior art is not needed.

The driver IC chip 112 in the embodiment 1 of the invention is the constant current circuit, and is designed to increase the input voltage and supply specified current in the light emitting elements 111a and 111b. Instead of such structure, the driver IC chip 112 may be a constant voltage circuit designed to increase the input voltage to supply specified voltage in the light emitting elements 111a and 111b.

In another structure, the driver IC chip 112 may include a constant voltage circuit for increasing the input voltage to a specific voltage and a constant current circuit for supplying a specific current in each one of plural light emitting elements connected in parallel. The driver IC chip 112 may include a constant current circuit for causing a specific current to flow into light emitting elements 111a and 111b by stepping down the input voltage, or a constant voltage circuit for applying specific voltage to the light emitting elements 111a and 111b by stepping down the input voltage.

In the light emitting device of the invention, since the light emitting elements 111 are mounted on the driver IC chip 112, as compared with the conventional light emitting device, the mounting area can be saved substantially.

According to the invention, as compared with protection by the discrete protective element using the zener diode in the prior art, multiple types of protective circuit can be included in the driver IC chip 112, and the dielectric strength of electrostatic breakdown of the external connection terminals of the luminous module 101 can be enhanced.

### Embodiment 2

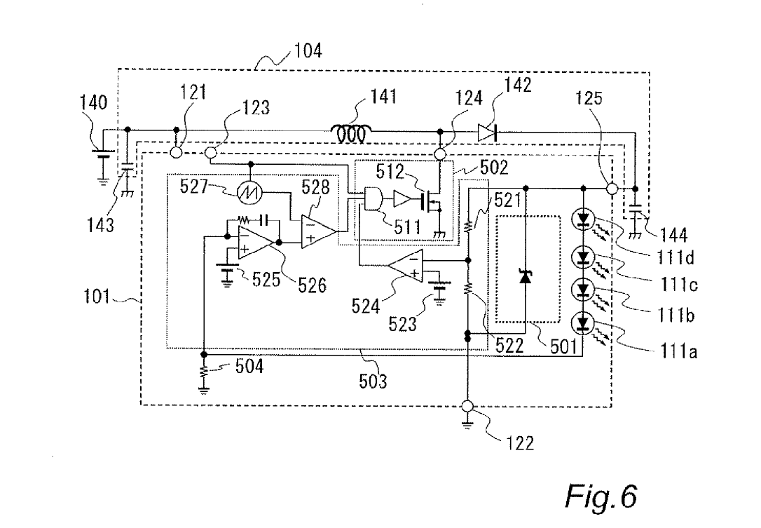

Referring to FIG. 6, a light emitting device in an embodiment 2 is explained. FIG. 6 is a circuit diagram of the light emitting device in the embodiment 2. In FIG. 6, same elements as in FIG. 5 are identified with same reference numerals. What the light emitting device in the embodiment 2 differs from the light emitting device in the embodiment 1 lies in that four light emitting elements 111 (111a, 111b, 111c, and 111d) are connected in series. Other structure is same as in the embodiment 1. Hence, duplicate explanation is omitted. In embodiment 2, since essential parts are identical, same effects as in the embodiment 1 are obtained.

The number and connection of light emitting elements 111 are not limited to the embodiment 1 or the embodiment 2, but an arbitrary number of light emitting elements may be connected, or plural light emitting elements and series resistors can be connected in parallel. The invention may be also realized by using only one light emitting element.

In the embodiments 1 and 2, one convex lens 119 is disposed above the light emitting elements 111, but a plurality of convex lenses may be disposed corresponding to the number of light emitting elements, For example, one convex lens may be combined with one light emitting element.

### Embodiment 3

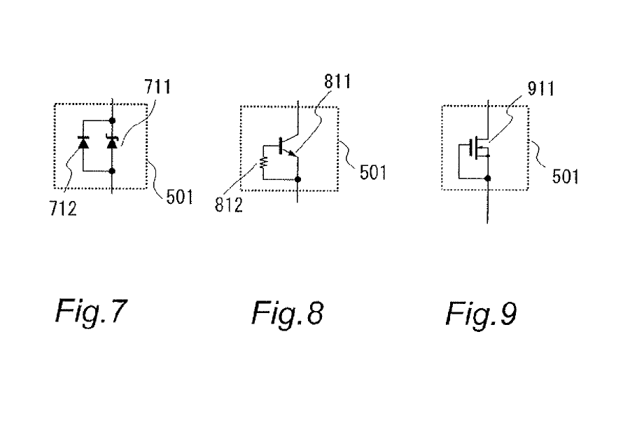

Referring to FIG. 7, a light emitting device in the embodiment 3 is explained. The light emitting device in the embodiment 3 differs from embodiment 1 (FIG. 5) only in the structure of the first protective circuit 501. FIG. 7 is a circuit diagram of the protective circuit of the light emitting device in the embodiment 3. The first protective circuit 501 in the embodiment 3 has a zener diode 711 and a diode 712 which are connected in parallel.

The diode 712 is mainly a PN junction. Cathodes of the zener diode 711 and the diode 712 are connected to the voltage feedback terminal 125 of the embodiment 1 in FIG. 5. Anodes of the zener diode 711 and the diode 712 are connected to the GND terminal 122 in FIG. 5. The first protective circuit 501 may have the diode 712 only.

In the embodiment 3, other structure than the first protective circuit 501 is same as in the embodiment 1. Hence, duplicate explanation is omitted. In the embodiment 3, since essential parts are identical, same effects as in the embodiment 1 are obtained. In this embodiment, same as in the embodiments 1 and 2, combination of number of light emitting elements and convex lenses is arbitrary.

### Embodiment 4

Referring to FIG. 8, a light emitting device in an embodiment 4 is explained. The light emitting device in the embodiment 4 differs from the embodiment 1 (FIG. 5) only in the structure of the first protective circuit 501. FIG. 8 is a circuit diagram of the protective circuit of the light emitting device in the embodiment 4. The first protective circuit 501 in the embodiment 4 has a NPN type bipolar transistor 811 and a resistor 812 connected between the base and emitter of NPN type bipolar transistor 811.

The emitter of NPN type bipolar transistor 811 is connected to the GND terminal 122 of the embodiment 1 in FIG. 5. The collector of NPN type bipolar transistor 811 is connected to the voltage feedback terminal 125 of the embodiment 1 in FIG. 5. The first protective circuit 501 in the embodiment 4 can adjust the dielectric strength voltage by varying the resistance value of the resistor 812. The protective circuit using bipolar transistor 811 is generally realized in a smaller area than the protective circuit using a diode.

In the embodiment 4, other structure than the first protective circuit 501 is same as in the embodiment 1. Hence, duplicate explanation is omitted. In the embodiment 4, since essential parts are identical, same effects as in the embodiment 1 are obtained. In this the embodiment, same as in the embodiments 1 and 2, combination of number of light emitting elements and convex lenses is arbitrary.

### Embodiment 5

Referring to FIG. 9, a light emitting device in an embodiment 5 is explained. The light emitting device in the embodiment 5 differs from the embodiment 1 (FIG. 5) only in the structure of the first protective circuit 501. FIG. 9 is a circuit diagram of the protective circuit of the light emitting device in the embodiment 5. The first protective circuit 501 in the embodiment 5 is a N channel MOS transistor 911.

A gate, a back gate, and a source terminal of the N channel MOS transistor 911 are connected in common to the GND terminal 122 of the embodiment 1 in FIG. 5. A drain of N channel MOS transistor 911 is connected to the voltage feedback terminal 125 of the embodiment 1 in FIG. 5. The protective circuit 501 using the N channel MOS transistor 911 is generally realized in a smaller area than the protective circuit using a diode.

In the embodiment 5, other structure than the first protective circuit 501 is same as in the embodiment 1. Hence, duplicate explanation is omitted. In the embodiment 5, since essential parts are identical, same effects as in the embodiment 1 are obtained. In this the embodiment, same as in the embodiments 1 and 2, combination of number of light emitting elements and convex lenses is arbitrary.

### Embodiment 6

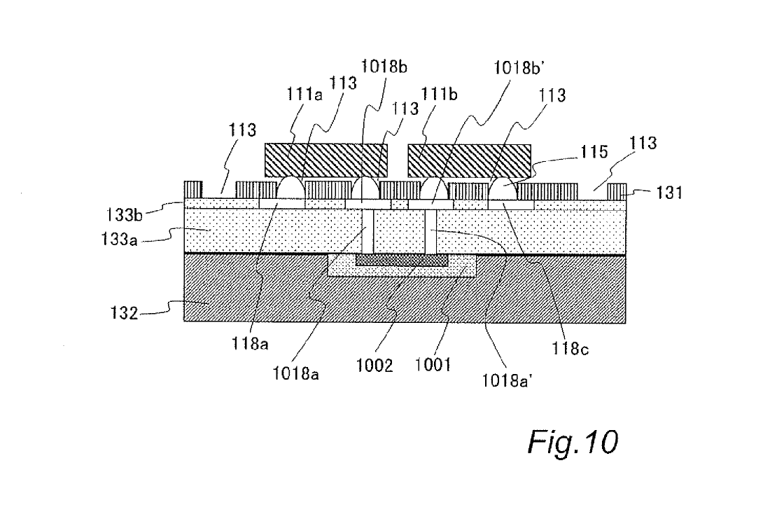

Referring to FIG. 10, a light emitting device in an embodiment 6 is explained. FIG. 10 is a partial magnified sectional view of the driver IC chip 112 in the embodiment 6. In FIG. 10, same elements as that of the embodiment 1 in FIG. 3 are identified with same reference numerals. What the light emitting device in the embodiment 6 differs from the embodiment 1 in FIG. 3 lies only in the connection of light emitting element 111a and light emitting element 111b.

In the light emitting device of the embodiment 6, P type diffusion resistor 1002 is disposed in the upper part of P type silicon substrate 132 which is the substrate of the driver IC chip 112, and the periphery of the P type diffusion resistor 1002 is covered with a N type well 1001. The upside of the P type silicon substrate 132 is covered with aluminum wirings 1018a, 1018a′, and the insulating film 133a. The upside of aluminum wirings and the insulating film 133a is covered with the insulating film 133b and aluminum wirings 118a, 1018b, 1018b′, and 118c.

The upside of the insulating film 133b and aluminum wirings 118a, 1018b, 1018b′, and 118c is covered with an insulating film 131 except for pad holes 113. The insulating film 131 in the embodiment 6 is polyimide. Bumps 115 are formed at specified position of pad holes 113, and light emitting elements 111a and 111b are mounted thereon. The light emitting element 111a is electrically connected to the light emitting element 111b by way of the bumps 115, the aluminum wiring 1018b, the aluminum wiring 1018a, the P type diffusion resistance 1002, the aluminum wiring 1018a′, and the aluminum wiring 1018b′.

In the embodiment 6, other structure is same as in the embodiment 1. Hence, duplicate explanation is omitted. In the embodiment 6, since essential parts are identical, same effects as in the embodiment 1 are obtained. In this the embodiment, too, the number of convex lenses may be two for adjusting to the number of the light emitting elements 111a and 111b.

### Embodiment 7

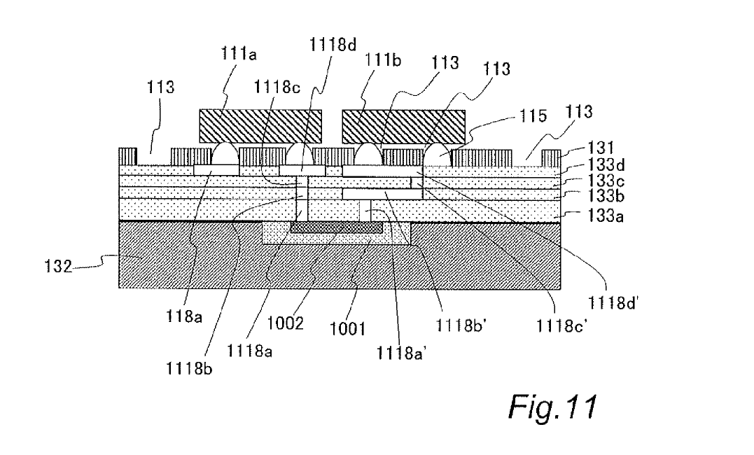

Referring to FIG. 11, a light emitting device in an embodiment 7 is explained. FIG. 11 is a partial magnified sectional view of the driver IC chip 112. In FIG. 11, same elements as that of the embodiment 1 in FIG. 3 and the embodiment 6 in FIG. 10 are identified with same reference numerals. What the light emitting device in the embodiment 3 differs from the embodiment 1 and the embodiment 6 lies only in the manner of connection of plural light emitting elements 111.

In the light emitting device of the embodiment 7, the P type diffusion resistor 1002 is disposed in the upper part of the P type silicon substrate 132 of the driver IC chip 112, and the periphery of the P type diffusion resistor 1002 is covered with the N type well 1001. The upside of P type silicon substrate 132 is covered with four layers of insulating films (133a, 133b, 133c, and 133d from the bottom), and four layers of aluminum wirings (1118a and 1118a′, 1118b and 1118b′, 1118c and 1118c′, and 118a, 1118d and 1118d′).

The upside of upper layer of the insulating film 133d and the aluminum wirings 118a, 1118d, and 1118d′ is covered with the insulating film 131 except for pad holes 113. The insulating film 131 in the embodiment 7 is polyimide. Bumps 115 are formed at specified position of pad holes 113, and light emitting elements 111a and 111b are mounted thereon. The light emitting elements 111a and 111b are electrically connected each other by way of the bumps 115, the four layers of aluminum wirings (1118a, 1118a′, 1118b, 1118b′, 1118c, 1118c′, 1118d, and 1118d′), and the P type diffusion resistor 1002.

In the embodiment 7, other structure is same as in the embodiment 1. Hence, duplicate explanation is omitted. In the embodiment 7, since essential parts are identical, same effects as in the embodiment 1 are obtained. In this the embodiment, too, a plurality of convex lenses 119 may be disposed according to the number of the light emitting elements 111.

### Embodiment 8

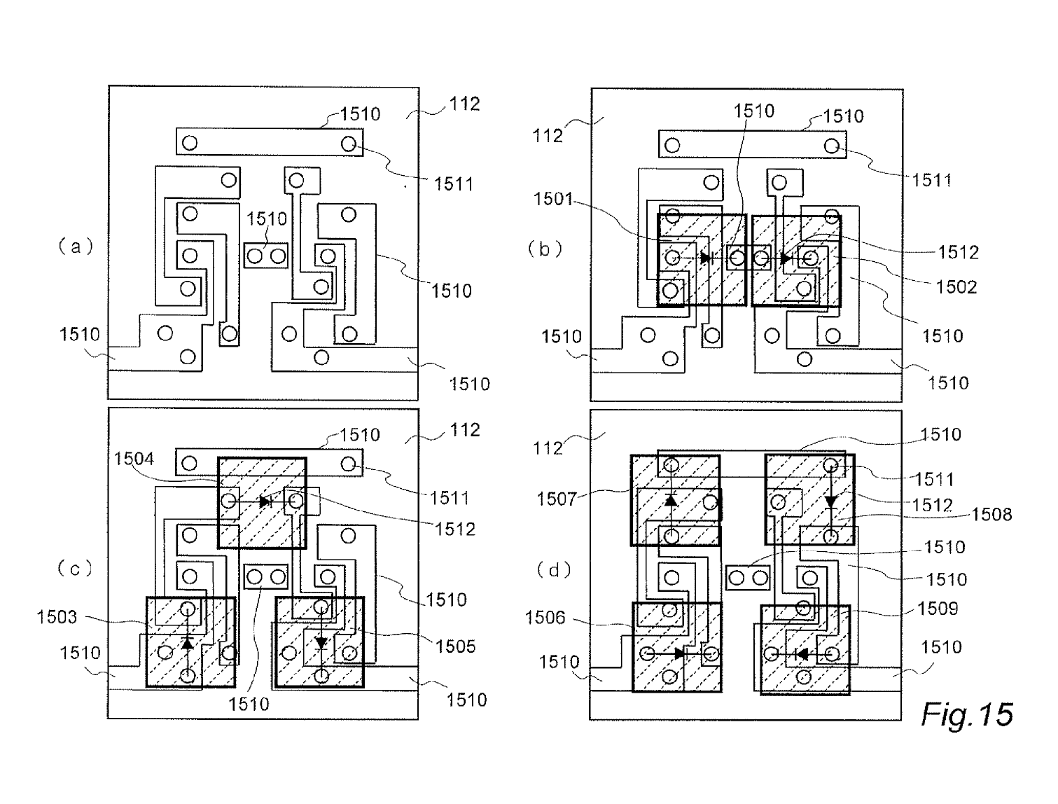

Referring to FIG. 15, a light emitting device in an embodiment 8 is explained. FIG. 15(a) is a plan view showing a shape of aluminum wirings as conductive path in the embodiment 8. FIG. 15(b) to FIG. 15(d) are diagrams showing two, three and four light emitting elements mounted on the aluminum wirings 1510, respectively. The aluminum wiring 1510 in FIG. 15(a) to FIG. 15(d) are identical in shape. The aluminum wirings 1510 of the light emitting device in the embodiment 8 have shapes capable of connecting any number of two to four light emitting elements electrically.

In the light emitting device in the embodiment 8, plural aluminum wirings 1510 are mounted on the driver IC chip 112. In FIG. 15(a) to FIG. 15(d), white circles 1511 of the aluminum wiring 1510 denote the position of bumps. The light emitting elements 1501 to 1509 are electrically connected to aluminum wirings 1510 by way of bumps mounted on the aluminum wirings 1510. What the light emitting device in the embodiment 8 differs from the embodiment 1 lies only in the shape of aluminum wirings 1510. In FIG. 15(b) and FIG. 15(c), current flowing paths 1512 are shown between the bump 1511 and bump 1511 for connecting the light emitting elements 1501 to 1509.

According to the embodiment 8 of the invention, by using only one kind of conductive path pattern (for example, a pattern of aluminum wirings 1510), plural light emitting devices having different numbers of light emitting elements can be manufactured only by changing the mounting location of light emitting elements 1501 to 1509. In the embodiment 8 of the invention, only one kind of mask for forming the conductive path pattern is enough. By combining one driver IC chip and arbitrary number of light emitting elements, the light emitting devices can be manufactured according to the demand, so that the stock of driver IC chips as materials of LED can be curtailed. A management cost in factory can be saved.

The driver IC chip 112 of the light emitting device in the embodiment 8 may also include external connection terminals for varying the current flowing in the light emitting elements or the voltage applied to the light emitting elements.

In the embodiment 8, other structures than the shape of aluminum wirings as conductive path are same as in the embodiment 1. Hence, duplicate explanation is omitted. In the embodiment 8, since essential parts are identical, same effects as in the embodiment 1 are obtained. In this the embodiment, a plurality of convex lenses may be disposed according to the number of the light emitting elements.

The light emitting devices in the embodiment 1 to the embodiment 8 may include a plurality of visible light emitting elements that emit light at different wavelengths. The light emitting devices in the embodiment 1 to the embodiment 8 may have plural visible light emitting elements that emit light in red, green and blue colors. An lighting device can be made by connecting a plurality of light emitting devices in the embodiment 1 to the embodiment 8 in parallel.

Although the present invention has been described with respect to its preferred embodiments in some detail, the disclosed contents of the preferred embodiments may change in the details of the structure thereof, and any changes in the combination and sequence of the component may be attained without departing from the scope and spirit of the claimed invention.

### INDUSTRIAL APPLICABILITY

The invention is useful for a semiconductor chip for driving light emitting elements, a light emitting device, and a lighting device.

1. A light emitting device comprising:
a light emitting element having an electric signal terminal, which is driven to emit light by an electric signal given to the electric signal terminal from outside; and
a semiconductor chip for driving the light emitting element, having a light emitting element drive circuit and a protective circuit that are made of semiconductors, the light emitting element drive circuit outputting and applying the electric signal to the electric signal terminal, the protective circuit being connected to a protective terminal for electrically connecting to the outside,
wherein the light emitting element is mounted on the semiconductor chip for driving the light emitting element through a insulating film and is connected to the semiconductor chip for driving the light emitting element by a connection matter penetrating the insulating film,
the light emitting element and the semiconductor chip for driving the light emitting element are connected to the outside through the protective terminal, respectively.

2. (canceled)

3. The light emitting device according to claim 1, wherein the protective circuit has one or a plurality of elements made by a same manufacturing method as elements forming the light emitting element drive circuit of the semiconductor chip for driving the light emitting element.

4. The light emitting device according to claim 1, wherein a plurality of light emitting elements formed from different chips are mounted on the surface of the semiconductor chip for driving the light emitting element, and
the semiconductor chip for driving the light emitting element has a conductive path for mutually connecting the light emitting elements.

5. The light emitting device according to claim 4, wherein the conductive path is made of a diffusion layer or a metal wiring layer formed by same processing method as a diffusion layer or a metal wiring layer forming the light emitting element drive circuit in the semiconductor chip for driving the light emitting element.

6. The light emitting device according to claim 4, wherein the conductive path has a resistance having a specified value.

7. The light emitting device according to claim 1, wherein the light emitting device has a plurality of visible light emitting elements emitting light at different wavelengths.

8. The light emitting device according to claim 7, wherein the light emitting elements include plural visible light emitting elements emitting three primary colors of red, green and blue.

9. The light emitting device according to claim 7, wherein the plurality of light emitting elements are disposed closely to a focus of a transmission type condensing lens combined in the light emitting device.

10. The light emitting device according to claim 7, wherein the plurality of light emitting elements are disposed near a focus of a reflection plane combined in the light emitting device.

11. A lighting device comprising:
a plurality of light emitting devices according to claim 1, each of that has the semiconductor chip for driving a light emitting element, having a constant current circuit that applies a specified current to the light emitting element or a constant voltage circuit that applies a specified voltage to the light emitting element.

12. A semiconductor chip for driving light emitting elements, on which the light emitting elements can be mounted, each of the light emitting elements having an electric signal terminal and being driven to emit light by an electric signal given to the electric signal terminal, the semiconductor chip comprising:
a light emitting element drive circuit that is made of a semiconductor, outputs and applies the electric signal to the electric signal terminal; and
a conductive path that mutually connects the electric signal terminals of the plurality of light emitting elements.

13. The semiconductor chip for driving light emitting elements according to claim 12, wherein P (P is a positive integer of 1 or more) light emitting elements formed by different chips and circuit elements of the light emitting element drive circuit are mutually connected through bumps provided on the conducive path.

14. The semiconductor chip for driving light emitting elements according to claim 13, wherein the conductive path has a conductive path shape such that Q (Q is a positive integer different from P) light emitting elements having nearly same shape as P light emitting elements are operable to be mounted, instead of P light emitting elements.

15. The semiconductor chip for driving light emitting elements according to claim 12, further comprising:
an external connection terminal that varies the value of current or voltage for driving light emitting elements.
